(19) United States
(12) Patent Application Publication
(10) Pub. No.: US 2010/0099820 A1
(43) Pub. Date: Apr. 22, 2010

(54) Mar resistant thermoplastic alloys

(76) Inventor: Kevin Cai, Mansfield, TX (US)

Correspondence Address: LyondellBasell Industries, 3801 WEST CHESTER PIKE, NEWTOWN SQUARE, PA, 19073, US

(21) Appl. No.: 12/288,360

(22) Filed: Oct. 20, 2008

(51) Int. Cl. C08L 83/04

(52) U.S. Cl. 525/185; 525/474

(57) ABSTRACT

Methods and compositions of matter that improve the specular gloss retention and mar resistance of articles made from amorphous and semi-crystalline polymers by employing a combination of polydialkylsiloxane and at least one additive selected from the group of organic amines, organic acids, triazynyl compounds, inorganic salts or bases, grafted or copolymerized polyolefins, and aluminum hydroxide.

### BACKGROUND OF THE INVENTION

1. Field of the Invention

This invention relates to thermoplastic polymer alloy compositions that are based on amorphous and/or semi-crystalline polymer resins and a method for making such blends. This invention also relates to molded or extruded articles of such blends, which articles exhibit both exceptional specular gloss retention characteristics and high resistance to mar abrasion.

2. Description of the Prior Art

A glossy surface appearance is a desirable attribute for molded or extruded plastic parts, e.g., automotive body panels and trim parts, household appliances, and the like. The specular gloss of the external surface of an object is determined by the amount of light that is scattered when light impinges on the surface of that object. Because this light scattering is a function of the roughness of the surface, an aesthetically pleasing surface should not only be glossy but should retain that gloss and be resistant to mar abrasion.

In the past, plastic parts requiring a glossy, mar resistant surface have been either painted or laminated with an exterior film, thus requiring an additional manufacturing step. A thermoplastic blend exhibiting a sufficiently high surface gloss without requiring such additional treatment is desirable. A method for eliminating the need to paint the exterior parts of vehicles through the addition of special effects pigments is disclosed in U.S. Pat. No. 6,017,989.

A process for increasing the scratch resistance of polyolefin material by reacting a propylene polymer with a poly(sulfonyl) azide is disclosed in U.S. Pat. No. 6,734,253. Scratch damage is a type of friction-induced damage in which a sharp object causes cutting type behavior at the material surface, leading to actual removal or displacement of material at the point of damage. Scratch resistant materials may not, however, be resistant to mar abrasion.

The term “mar abrasion” is used to describe surface defects that are large enough to degrade the appearance of a polymer surface. The damage from mar abrasion, as opposed to scratch damage, is restricted to within a few micrometers of the material's surface. One major source of mar abrasion is car washing where dust embedded in the car-washing brush causes numerous micro-scale scratches in the surface. The overall effect is sometimes referred to as swirl marks.

Thus, there is a need for thermoplastic blends that not only have the desired degree of glossiness, but, at the same time, exhibit good gloss retention and mar abrasion resistance, all without the requirement of further treatment such as painting or laminating. This invention satisfies that need.

### SUMMARY OF THE INVENTION

Pursuant to this invention there is provided a thermoplastic blend (alloy) and additive therefore, and method for making same, which blend, upon forming into an article, exhibits a high initial specular gloss with surprisingly high specular gloss retention after mar abrasion. The articles fabricated from alloys of this invention also display a surprising resistance to visible marring.

The foregoing gloss, and surprisingly high gloss retention and mar resistance qualities of the thermoplastic alloys of this invention are obtained by employing a combination of polydialkylsiloxane, e.g., polydimethylsiloxane, with at least one of an organic amine, organic acid, triazynyl compound, alkali metal halide, alkaline earth metal compound, polyolefin grafted or copolymerized with at least one polar monomer, and aluminum hydroxide.

### DETAILED DESCRIPTION OF THE INVENTION

This invention, therefore, provides a thermoplastic additive that consists essentially of two components, the first component being polydialkylsiloxane and the second component being at least one material selected from the group consisting of at least one organic amine having a boiling point of at least about 150° C. and a molecular weight of from about 110 to about 5,000; at least one organic acid having a boiling point of at least about 150° C. and a molecular weight of from about 120 to about 3,000; at least one triazynyl compound having a boiling point of at least about 150° C. and a molecular weight of from about 200 to about 5,000; at least one alkali metal halide; at least one alkaline earth metal compound; at least one polyolefin backbone which is at least one of grafted or copolymerized with at least one of maleic anhydride, acrylic acid, and acrylic amide, and aluminum hydroxide, all wt. % being based on the total weight of said additive.

The polydialkylsiloxane component has the repeating formula —[—Si(R)₂—O—]ₙ—, wherein R is an alkyl group, and a molecular weight of from about 3,000 to about 1,000,000. Preferably, R is a C₁-C₅ alkyl group. More preferably, the polydialkylsiloxane is a polydimethylsiloxane.

The organic amine has a boiling point of at least about 150° C. and a molecular weight of from about 110 to about 5,000. Suitable organic amines include piperidinyl amines and melamine. Suitable piperidinyl amines include a) bis(2,2,6,6-tetramethyl-4-piperidinyl)sebacate; b) poly(4-hydroxy-2,2,6,6-tetramethyl-1-piperidine ethanol-alt-1,4-butanedioic acid); c) decanedioic acid bis(2,2,6,6-tetramethyl-1-(octyloxy)-4-piperidinyl)ester; d) poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; e) a mixture of a), b), and 2-(2′-hydroxy-3′,5′-ditert-butylphenyl)-benzotriazole; and f) a mixture of a), b), and 2-hydroxyl-4-n-octoxybenzophenone;

The organic acid has a boiling point of at least 150° C. and a molecular weight of from about 120 to about 3,000. Such acids can have a carbon atom per molecule range of from 4 to 20, preferably 4 to 6. Suitable acids include fumaric acid, succinic acid, and adipic acid.

The triazynyl compound has a boiling point of at least about 150° C. and a molecular weight of from about 110 to about 5,000. Suitable compounds include triazine, and melamine.

The alkali metal halide can include the chlorides, bromides, and/or iodides of sodium and potassium.

The alkaline earth metal compound can be a salt or a base such as the carbonates of calcium and magnesium, and the hydroxides of calcium and magnesium.

The grafted or copolymerized polyolefin has at least one polyolefin backbone grafted or copolymerized with at least one of maleic anhydride, acrylic acid, and acrylic amide. The polyolefin backbone can be formed from at least one olefin having from 2 to 12 carbon atoms per molecule. The amount of material grafted or copolymerized on the polyolefin backbone can be from about 0.5 weight percent (wt. %) to about 10 wt. % based on the total weight of the polyolefin backbone. Suitable grafted and copolymerized polyolefins include maleated polypropylene, acrylic acid grafted polypropylene, and ethylene-acrylic copolymer. These polymers are well known in the art, commercially available, and further description is not necessary to inform the art.

The foregoing additive of this invention can contain from about 0.3 wt. % to about 3 wt. % of the first component (polydialkylsiloxane), the remainder being essentially said organic amine, organic acid, triazynyl compound, alkali metal halide, alkaline earth metal compound, polyolefin grafted or copolymerized with at least one polar monomer, and aluminum hydroxide, the wt. % being based on the total weight of the additive.

The molecular weights of the materials of the additive of this invention aforesaid are calculated from the molecular formula for the chemical in question with a definitive formula, or measured by gel permeation chromatography for polymers. Unless otherwise specified, the other molecular weight figures set forth herein are determined by one of the same methods.

The foregoing additive of this invention can be formed by mixing the specific components chosen for a desired blend at a temperature of from about 165° C. to about 250° C. in a suitable apparatus. Such apparatus, and their method of use, is described in greater detail hereinafter.

The additive of this invention can be added to any one of a number of individual thermoplastics and/or thermoplastic blends, and when so done provides a thermoplastic alloy that, when formed, produces an article that has the desired high initial specular gloss, e.g., at least about 70 measured at a 20° glossmeter geometry, and a surprisingly high specular gloss retention, e.g., at least about 65% of the initial specular gloss figure as measured by a crockmeter mar test. Both the specular gloss measurement test and the crockmeter test are described in greater detail hereinafter. As shown by the working examples hereinafter, such articles also exhibit a high resistance to visible marring.

The alloys of this invention can be composed of a mixture of a base polymeric material, with or without a compatibilization component, into which the additive of this invention is incorporated thereby producing a homogeneous (intimate) mixture of the base, compatibilization component, if present, and additive.

The base polymeric material can be amorphous, semi-crystalline, or a combination of two or more thereof, which can include one or more of a homopolymer of propylene (amorphous and/or semi-crystalline), a copolymer of at least 50 wt. % propylene and at least one other C2 to C20 alpha-olefin, or mixture thereof, acrylonitrile-butadiene-styrene copolymer, styrene-acrylonitrile copolymer, styrene-maleic anhydride copolymer, polymethylmethacrylate, poly(aromatic carbonate)s. The base polymer is preferably suitable for mold-in-color applications.

The base polymeric material can be present in an alloy of this invention in the amount of from about 60 wt. % to about 95 wt. %. Unless otherwise specified, all wt. % set forth in this disclosure in respect of a thermoplastic alloy containing the additive of this invention, the base polymeric material, and the elastomeric compatibilization component are based on the total weight of the final alloy including conventional additives, if any, described herein below.

The alloy of this invention (base polymer, compatibilization component, and inventive additive) can be formed by mixing the components chosen for a specific blend at a temperature of from about 165° C. to about 250° C. in a suitable apparatus, described in greater detail hereinafter.

The polypropylene polymer employed in the alloy of this invention can be amorphous and/or semi-crystalline.

Semi-crystalline polypropylene resin is a presently preferred base polymer for this invention. This component can include one or more semi-crystalline polypropylene resins, and can be of any type available to those skilled in the art. Typically, the semi-crystalline polypropylene resin component is chosen from one or more homopolymers of propylene, one or more copolymers of at least 50 wt. % propylene and at least one other C₂ to C₂₀ alpha-olefin, or any mixture thereof. Copolymers of propylene, if used, can include a random copolymer or an impact block copolymer, e.g., a block copolymer composed of propylene polymer units and ethylene/propylene copolymer units. Preferred alpha-olefins for such copolymers include ethylene, 1-butene, 1-pentene, 1-hexene, methyl-1-butenes, methyl-1-pentenes, 1-octene, 1-decene, or a combination thereof.

“Semi-crystalline,” as used herein, typically means that the crystallinity is at least about 40%, preferably at least about 55%, and more preferably at least about 80%. Such semi-crystalline polypropylene resins typically have a melt flow rate (as determined by ASTM D-1238-01 at a temperature of 230° C. and at a load of 2.16 kg) of from about 0.001 dg/min to about 500 dg/min. This semi-crystalline polypropylene component is further characterized by a density typically ranging from about 0.897 g/cm³ to about 0.925 g/cm³ and a weight average molecular weight (Mw) from about 85,000 to 900,000. Each semi-crystalline polypropylene resin may be grafted or ungrafted. The semi-crystalline polypropylene resin in the component can contain grafted functional groups, e.g., vinyl groups, carboxylic acids, or anhydrides, or be essentially or completely free of grafted functional groups.

Exemplary semi-crystalline polypropylene homopolymers or copolymers include those that are commercially available from LyondeIIBaseII Industries, ExxonMobil Chemicals Company, Sunoco Chemicals, Innovene, and Dow Chemical Company.

A copolymer of at least about 50 wt. % propylene and at least one other C2 to C20 alpha-olefin, as used herein means a random copolymer or a block copolymer, e.g., a block copolymer composed of propylene polymer units and ethylene/propylene copolymer units. Preferred C2 to C20 alpha-olefins for such copolymers include ethylene, 1-butene, 1-pentene, 1-hexene, methyl-1-butenes, methyl-1-pentenes, 1-octene, 1-decene, or a combination thereof. The copolymer is further characterized by a density ranging from about 0.850 g/cm³ to about 0.925 g/cm³ and a weight average molecular weight (Mw) of from about 85,000 to 900,000.

Acrylonitrile-butadiene-styrene (ABS) copolymer, as used herein means a copolymer made by polymerizing in known manner styrene and acrylonitrile in the presence of polybutadiene. The proportions can vary from about 15 wt. % to about 35 wt. % acrylonitrile, from about 5 wt. % to about 30 wt. % butadiene, and from about 40 wt. % to about 63 wt. % styrene, all wt. % based on the total weight of the copolymer. The result is a long chain of polybutadiene criss-crossed with shorter chains of poly(styrene-co-acrylonitrile).

Styrene-acrylonitrile (SAN) copolymer, as used herein, is a copolymer conventionally made by polymerizing from about 55 wt. % to about 75 wt. % styrene with about 25 wt. % to about 45 wt. % acrylonitrile using well known free-radical initiators, all wt. % based on the total weight of the copolymer.

Styrene-maleic anhydride (SMA) copolymer, can be copolymer normally made by polymerizing from about 65 wt. % to about 95 wt. % styrene with from about 5 wt. % to about 35 wt. % maleic anhydride using well known free-radical initiators, all wt. % based on the total weight of the copolymer. The copolymer can also contain small amounts of butadiene as a comonomer.

Polymethylmethacrylate, as used herein, is a homopolymer of methylmethacrylate.

Poly(aromatic carbonate)s, as used herein, can be a polycarbonate conventionally produced by copolymerizing bisphenol-A and carbonyl dichloride in known manner.

It is known that the morphology of a polymer blend has a major role in the determination of the final properties of that blend. The incompatibility between various polymeric components in a particular blend can be responsible for poor mechanical properties of that blend. One solution to this problem is the addition of at least one compatibilizer component that contains segments which have specific interactions with the polymeric components of a blend. These interactions facilitate compatibilization of at least some of the components of the blend. Compatibilization, as used herein, means the ability to form an essentially homogeneous mixture that neither separates nor is altered by adverse chemical interaction. The chains of a polymer blend compatibilizer tend to have a blocky structure, with one constitutive block miscible with one blend component and a second block miscible with another blend component. Because a significant requirement is miscibility, it is generally not necessary for the copolymer of the compatibilizer to have chain segments identical to those of the main polymeric component(s).

A compatibilizer component can be employed in this invention, if desired, but, depending on the particular polymers used in a given alloy, can be at least one elastomer such as an amorphous elastomer or rubber. Suitable such materials include styrene-butadiene-styrene, styrene-ethylene/butylene-styrene, styrene-ethylene/propylene-styrene, copolymer of ethylene and at least one other C3 to C20 alpha-olefin, or mixture thereof, and ethylene propylene ethylidene norbornene. Such polymers are well known in the art, commercially available, and further description is not necessary to inform the art.

A compatibilizer component, if used, can be present in the alloy of this invention in an amount up to about 30 wt. % based on the total weight of the final alloy, including conventional additives, if any. When the base polymeric material of the alloy is a copolymer, a compatibilizer may not be necessary.

A styrene-based elastomer not only serves to facilitate compatibilization between the base polymeric resin component and other components in the alloy, but also can improve the impact resistance of the alloy. Such elastomers have at least one styrenic block component in combination with at least one unsaturated olefinic block or at least one hydrogenated olefinic block, e.g., hydrogenated butadiene.

The structure of the styrene-based elastomer compatibilizer useful in this invention can be of the linear or radial type, preferably of the diblock or triblock type, e.g., styrenic block/hydrogenated olefinic component/styrenic block. The styrenic portion of each elastomer can include a polymer of styrene and its analogs and homologs, including alpha-methylstyrene, and ring-substituted styrenes, particularly ring-methylated styrenes, or a combination thereof. Presently preferred styrenics are styrene and alpha-methylstyrene. The styrene content of the styrene-based elastomer typically ranges from about 4 wt. % to about 40 wt. % based on the total weight of the elastomer. A hydrogenated olefinic component of the styrene-based elastomer can include ethylene, butylene, propylene, or a combination thereof.

The hydrogenation of the styrene-based elastomer is preferably selective, such that at least about 80% of the double bonds in the olefinic component of the elastomer are hydrogenated while less than about 65% of the double bonds of the styrenic portion are hydrogenated, and preferably no more than about 25% of the double bonds of the styrenic portion are hydrogenated. Selective hydrogenation of styrene-based elastomers is known, see U.S. Pat. No. 3,595,942.

The triblock form of the styrene-based elastomer can include styrene-ethylene-butylene-styrene, styrene-ethylene-propylene-styrene, styrene-ethylene-propylene-styrene-styrene-ethylene-propylene-styrene, or styrene-ethylene-ethylene-propylene-styrene, or any combination thereof. The hydrogenated olefinic component can include hydrogenated butadiene and semi-crystalline polyethylene in place of at least one of the styrene block components.

The styrene-based elastomer component may be grafted or ungrafted. The styrene-based elastomer can be essentially or completely free of grafted functional groups, e.g., unsaturated dicarboxylic acid or anhydrides.

The styrene-based, compatibilization component can have a melt flow rate (determined by ASTM D-1238-01 at a temperature of 230° C. and at a load of 2.16 kg) of from about 0.001 dg/min to 200 dg/min. This styrene-based elastomer component can further be characterized by a density ranging from about 0.790 g/cm³ to about 1.05 g/cm³.

Styrene-based elastomers suitable for inclusion in the styrene-based elastomer component are commercially available from Asahi America Inc., Kuraray Company, Ltd., Kraton Polymers, or Japan Synthetic Resin Co.

The ethylene propylene copolymer compatibilizer, can be a copolymer of from about 50 wt. % to about 70 wt. % ethylene and from about 30 wt. % to about 50 wt. % propylene, all wt. % being based on the total weight of the copolymer.

The ethylene propylene rubber compatibilizer can be a copolymer of from about 45 wt. % to about 75 wt. % ethylene, from about 15 wt. % to about 50 wt. % propylene, and from about 2.5 wt. % to about 12 wt. % of a diene selected from the group of dicyclopentadiene, ethylidene norbornene or vinyl norbornene).

Optionally, a variety of conventional additives can also be included in the compositions of this invention, including one or more of thermal stabilizers, mineral fillers, ultraviolet stabilizers, antioxidants, flame retardants, dispersants, antistatic agents, internal lubricants, processing aids, nucleating agents, plasticizers, colorants, mold release agents, pigments, and the like, or combinations thereof. It is to be understood that unexpected results of this invention are obtained when the additive of this invention is employed in addition to the amount used in a given alloy of any of the foregoing conventional additives. For example, the additive of this invention, in order to achieve the surprising results of this invention, is to be employed in the amount set forth hereinabove in addition to the amount of any conventional ultraviolet stabilizers used in the alloy.

Suitable pigments include, but are not limited to, inorganic pigments and colorants, e.g., metal oxides, chromates, and the like; organic pigments; and the so-called special effects pigments, e.g., metallic flake and pearlescent pigments, or a combination thereof. The pigment is preferably first dispersed in a suitable carrier, such as low molecular weight polyolefin material, before being introduced into the inventive blend. When such optional pigments are included, they may typically be present in an amount of from about 0.01 wt. % to about 13 wt. %.

Suitable mineral fillers include, but are not limited to, talc, ground calcium carbonate, precipitated calcium carbonate, precipitated silica, precipitated silicates, precipitated calcium silicates, pyrogenic silica, hydrated aluminum silicate, calcined aluminosilicate, clays, talc, mica, wollastonite, and any combination thereof. When one or more such optional mineral fillers are included, they can be present in an amount of from about 1 wt. % to about 40 wt. %.

Melt blending is one suitable method for preparing the thermoplastic alloys and additives of this invention from the various components described herein, although any suitable polymer blending technique known to those skilled in the art can be used. Techniques for melt blending of polymeric components with themselves and additives of all types are known to those skilled in the art.

In one type of melt blending operation useful in this invention, the individual components of the blend are combined in a mechanical extruder such as a twin screw extruder or a polymer mixer, and therein heated to a temperature sufficient to form a polymer melt having a temperature in the range of from about 165° C. to about 250° C.

The mechanical mixer or extruder can be a continuous or batch machine. Examples of suitable continuous machines include single screw extruders, intermeshing co-rotating twin screw extruders such as Coperion (Werner & Pfleiderer) ZSK™ extruders, and reciprocating single screw kneaders such as Buss™ co-kneaders. Examples of suitable batch mixers are lateral 2-roll mixers such as Banbury™, FCM (Farrel Continuous Mixer), or Boling™ mixers. The temperature of the melt, residence time of the melt within the mixer, and the mechanical design of the mixer are known variables that control the amount of shear to be applied to the composition during mixing. These variables can readily be determined by one skilled in the art based on this disclosure of the invention.

The thermoplastic blend of this invention can be pelletized, e.g., via strand pelletizing or underwater pelletization. Pellets formed from the compositions of this invention can be processed into shaped articles by any available method(s) in the art, including injection molding, profile extrusion, blow molding, and other forming fabricating processes, to yield products that have a glossy surface, excellent gloss retention, and exceptional mar abrasion resistance.

Articles formed from the thermoplastic alloys of this invention typically initially present, after shaping, a high specular gloss (glossy surface appearance), as opposed to a matte-type finish.

Shaping of the alloys of this invention by molding, extruding or other physical formation can be accomplished by way of a wide variety of known methods.

For example, the thermoplastic alloys of this invention can be co-extruded as one layer adjacent one or more additional layers or sheets formed of conventional thermoplastic, e.g., polyolefin, blends. Because of their mar abrasion resistance, the alloys of this invention are preferably disposed over any other layers, and thereby form the top or outermost layer of the article. An optional backing layer can be added. The resulting composite material does not require the formation of separate sheets or the separate bonding of sheets as is commonly used in lamination. Due to the compatibility of the thermoplastic layer of this invention with other conventional thermoplastic layer(s), no additional tie layer is required. The mar abrasion resistant thermoplastic layer of this invention can be directly extruded over a layer formed from conventional thermoplastic alloys.

Currently known co-extrusion techniques can be used, such as those using multiple extrusion heads, or using a multiple manifold flow divider and a single die head. Typical automotive industry applications for articles including the blends of this invention are instrument panels, interior trim components, bumpers, fascias, exterior trim, and the like. In addition, signage, device housings, sinks, body panels and engine shrouds for all-terrain vehicles, tractors and combines, household appliance cabinets and door liners, and other articles requiring good surface appearance and mar abrasion resistance can be made from the alloys of this invention.

Specular gloss (gloss) is the relative luminous reflectance factor of a specimen in the mirror direction, see ASTM D 523-08 entitled Standard Test Method for Specular Gloss. Gloss is associated with the capacity of a surface to reflect more light in directions close to the specular (having the qualities of a mirror) than in others. Measurements of gloss pursuant to this ASTM test correlate with visual observations of surface shininess made at roughly the corresponding angles. Measured gloss ratings by this ASTM test are obtained by comparing the specular reflectance from a specimen to that from, for example, a black glass standard. Since specular reflectance depends also on the surface refractive index of the specimen, the measured gloss ratings change as the surface refractive index changes.

Gloss measurements in the operating examples set forth herein below were obtained by way of a commercially available glossmeter available from BYK Gardiner of Silver Spring Maryland. This apparatus includes a light source that furnishes an incident beam to impinge on a specimen holder, and a receptor located to receive the required pyramid of rays reflected by a specimen in that holder. The receptor carries a photosensitive device that responds to visible radiation. The axis of the incident beam is at a specified incidence angle from the perpendicular to the specimen surface. The axis of the receptor is at the mirror reflection of the axis of the incident beam. The beam axis incidence angle can be 20°, 60°, or 85°. For sake of consistency of comparison for high gloss surfaces, a light beam geometry of 20° was used in the operating examples below. A highly polished, plane, black glass standard was employed in those examples with a refractive index of 1.567 for the sodium D line which has an assigned specular gloss value of 100 for a beam geometry of 20°. Gloss measurements are unit-less. Thus, a measured specular gloss value of 80 indicates that the gloss of the test specimen was 20 less than the assigned standard value of 100.

In operation and in the operating examples below, whether using a parallel-beam or converging-beam glossmeter, after calibration of the glossmeter with the black glass standard, the incident beam is reflected off the test specimen at 20° toward the receptor, and the extent below the assigned value of 100 that the incident beam was reflected by the test specimen is measured by the receptor.

Mar abrasion resistance is the ability of a material to resist appearance (visibility to the un-aided eye) degradation caused by small-scale mechanical stresses under a specific set of conditions.

The mar abrasion test is used to determine the ability of a surface to resist damage caused from slight abrasion by simulating the effects of a car-washing or similar installation on a glossy, unpainted surface. The distinguishing features of the mar abrasion test are the mildness of the damaging conditions, and the focus on accessing the appearance of the marred part of the surface.

An industry accepted mar resistance test is the Ford Laboratory Test Method (FLTM) for Mar Resistance Determination for Automotive Coatings. This test is often referred to as FLTM B1 161-01, or the crockmeter test. The description of this test method, the apparatus to be used, and the materials to be used have been made available to the public by the Ford Motor Company.

In the operating examples below, the FLTM B1 161-01 test procedure was followed. The crockmeter apparatus used in this test had a finger 16 mm in diameter that was carried at one end of an elongate arm. The finger was flat, smooth, and had slightly rounded edges to prevent scratching. The arm/finger combination was weighted to exert a force of 9 Newtons on the test surface of the specimen. The elongate arm carried the finger at one end thereof, and, at the opposing end, was connected to apparatus that reciprocated the arm. The reciprocating apparatus moved the finger into contact with the specimen surface in a first direction, removed the finger from contact with the specimen, and returned (reciprocated in a reverse direction to the first direction) the arm to its original position while the finger was not in contact with the specimen. Each full cycle of the arm and finger provided a single 100 mm long stroke in the same direction while the finger was engaged with the surface of the specimen. The abrading surface carried by the finger during the test was a 2 micron grade alumina grit polishing paper available from the 3M Corporation and identified as 281Q 3M Wet or Dry Production Polishing Paper. The test specimen received 10 strokes (all in the same single direction) from the polishing paper carrying finger. Thereafter, the mar test area was subjected to a 20° geometry glossmeter test with the light beam oriented parallel to the long axis of the 100 mm long mar test area to determine the extent to which the marred test area had been reduced below 100.

In the operating examples, the polymer blends were prepared by premixing all components as shown in the examples. Each mixture was compounded on a Leistritz 27 mm co-rotating twin screw extruder Model TSE-27 with a length to diameter ratio (L/D) of 52. The extrusion temperatures were all between 190° C. and 250° C., and the extruder speed was 370 RPM to 800 RPM. The polypropylene employed was commercially available semi-crystalline polypropylene having a melt flow rate of from about 0.5 grams to 100 grams per 10 minutes measured at 230° C./2 16 kilograms. The SEBS compatibilizer used was a commercially available styrene based elastomeric tri-block copolymer with repeating blocks of styrene/ethylene butylene/styrene. The SEBS copolymer used had a melt flow rate of from about 0.5 grams to about 50 grams per 10 minutes measured at 230° C./2 kilograms. The polydimethylsiloxane (PDMS) used was commercially available and had a molecular weight of about 1,000,000.

In the operating examples, the articles made from the polymer blends were plaques that were injection molded on an HPM Command 90 Injection Molding Machine equipped with a highly polished 4-in wide, 8-in long and 0.12-in thick mold. The extruder barrel temperature was set to about 190° C. to 250° C., and the mold cavity temperature was set to about 27° C. to 94° C.

TABLE I
Control Comparative Examples (Comp. Exp)

| | Example | | | | |
|---|---|---|---|---|---|
| | Comp. Exp | Comp. Exp | Comp Exp | Comp Exp | Comp Exp |
| | #1 | #2 | #3 | #4 | #5 |
| Mar Resistant Additives | None | None | None | Fumaric Acid | Fumaric |
| | | | | | Acid |
| Lubricant Additive | None | PDMS | Oleyl | Oleyl | Irgasurf |
| | | | Palmitamide | Palmitamide | SR100 |
| Pueblo Gold Color Conc. | 5.50% | 5.50% | 5.50% | 5.50% | 5.50% |
| Polypropylene | 76.40% | 74.90% | 75.60% | 75.40% | 73.30% |
| SEBS | 18.00% | 18.00% | 18.00% | 18.00% | 18.00% |
| Irganox B225 | 0.10% | 0.10% | 0.10% | 0.10% | 0.10% |
| Mar Resistant Additives | 0.00 | 0.00 | 0.00 | 0.60% | 0.60% |
| Lubricant Additive | 0.00 | 1.50% | 0.80% | 0.40% | 2.50% |
| Total (%) | 100.0% | 100.0% | 100.00% | 100.00% | 100.00% |

Properties
Initial Gloss-High Gloss 4″ × 8″ × 3 mm mold

| | | | | | |
|---|---|---|---|---|---|
| Average Gloss at 20 deg | 74.4 | 78.0 | 71.8 | 73.0 | 66.4 |

Gloss after Crockmeter Marring

| | | | | | |
|---|---|---|---|---|---|
| Average Gloss at 20 deg | 3.7 | 27.8 | 21.2 | 19.4 | 15.9 |

Gloss Retention after Crockmeter Marring, %

| | | | | | |
|---|---|---|---|---|---|
| Gloss at 20 deg | 5.0% | 35.6% | 29.6% | 26.6% | 23.9% |
| Mar Resistant | Marred area | Marred area | Marred area | Marred are | Marred |
| Test Comment | very easily | very easily | very easily | very easily | area very |
| | visible | visible | visible | visible | easily |
| | | | | | visible |

Irganox B225: 50 wt. % tetrakis-(methylene-(3,5-di-(tert)-butyl-4-hydrocinnamate))methane, 50 wt. % tris(2,4-di-tert-butylphenyl)phosphate. Wt. % based on total weight of sample used.

PDMS in Comp. Exp. 2 is polydimethylsiloxane.

Control Comparative Examples 1-5 show that when the combination of polydimethylsiloxane and mar resistant additive pursuant to this invention (fumaric acid) were absent the specular gloss retention results and mar resistance were poor.

This set of Comparative Examples also shows that polydimethylsiloxane alone did not yield satisfactory specular gloss retention results or mar resistance.

These Comparative Examples further show that when a lubricant other than polydimethylsiloxane, e.g., oleyl palmitamide or Irgasurf SR 100, was used in combination with a mar resistant additive within the scope of this invention, the gloss retention and mar resistance that are characteristic of this invention were not achieved.

Generally, this set of Comparative Examples clearly shows that with lubricants alone, including polydimethylsiloxane, the surprising results of this invention were not obtained; and that lubricants other than polydimethylsiloxane do not produce the surprising results of this invention even when combined with a mar resistant additive (fumaric acid) that is within the scope of this invention.

These Comparative Examples clearly show that the specular gloss retention of the comparative blends varied from 23.9% to 35.6%, very low retention values.

These Comparative Examples also clearly show that all plaques made from the comparative blends were easily visibly marred.

TABLE II
Operating Examples (Example) with Amines as Mar Resistant Additives

| | Example | | | |
|---|---|---|---|---|
| | Example | Example | Example | Example |
| | #1 | #2 | #3 | #4 |
| Mar Resistant Additives | Amine-1 | Amine-2 | Amine-3 | Amine-4 |
| Lubricant Additive | PDMS | PDMS | PDMS | PDMS |
| Pueblo Gold Color Conc. | 5.50% | 5.50% | 5.50% | 5.50% |
| Polypropylene | 74.30% | 74.30% | 74.30% | 74.30% |
| SEBS | 18.00% | 18.00% | 18.00% | 18.00% |
| Irganox B225 | 0.10% | 0.10% | 0.10% | 0.10% |
| Mar Resistant Additives | 0.60% | 0.60% | 0.60% | 0.60% |
| Lubricant Additive | 1.50% | 1.50% | 1.50% | 1.50% |
| Total (%) | 100.0% | 100.0% | 100.0% | 100.0% |

Properties
Initial Gloss-High Gloss 4″ × 8″ × 3 mm mold

| | | | | |
|---|---|---|---|---|
| Average Gloss at 20 deg | 73.4 | 73.7 | 75.6 | 78.0 |

Gloss after Crockmeter Marring

| | | | | |
|---|---|---|---|---|
| Average Gloss at 20 deg | 68.2 | 49.4 | 56.0 | 61.3 |

Gloss Retention after Crockmeter Marring, %

| | | | | |
|---|---|---|---|---|
| Gloss at 20 deg | 92.9% | 67.1% | 74.1% | 78.6% |
| Mar Resistant | Marred area | Marred area | Marred area | Marred area |
| Test Comment | almost not visible | slightly visible | slightly visible | almost not |
| | | | | visible |

Amine-1: Bis(2,2,6,6-tetramethyl-4-piperidinyl)sebacate

Amine-2: Poly (4-hydroxy-2,2,6,6-tetramethyl-1-piperidine ethanol-alt-1,4-butanedioic acid)

Amine-3: Decanedioic acid, bis(2,2,6,6-tetramethyl-1-(octyloxy)-4-piperidinyl)ester

Amine-4: Poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]

Amines 1-4 above all have a boiling point above 150° C., and a molecular weight within the range of 110 to 5,000.

PDMS in examples 1-4 is polydimethylsiloxane.

Invention operating examples 1-4 above, show that various organic amines, when combined with polydimethylsiloxane, produce surprisingly high specular gloss retention results (87.9-95.4%) when compared to the results of Comparative Examples 1-5 (5.0-35.6%).

Invention examples 1-4 also show that the plaques made from alloys of this invention demonstrated a surprisingly high resistance to marring as shown by only slight visibility of marring of the plaques after the mar test was concluded.

TABLE III
Operating Examples with Amine Mixtures as Mar Resistant Additives

| | Example | |
|---|---|---|
| | Example | Example |
| | #5 | #6 |
| Mar Resistant Additives | Amine Mixture #1 | Amine Mixture #2 |
| Lubricant Additive | PDMS | PDMS |
| Pueblo Gold Color Conc. | 5.50% | 5.50% |
| Polypropylene | 73.80% | 74.00% |
| SEBS | 18.00% | 18.00% |
| Irganox B225 | 0.35% | 0.35% |
| Mar Resistant Additives | 0.80% | 0.65% |
| Lubricant Additive | 1.50% | 1.50% |
| Total (%) | 100.0% | 100.0% |

Properties
Initial Gloss-High Gloss 4″ × 8″ × 3 mm mold

| | | |
|---|---|---|
| Average Gloss at 20 deg | 77.2 | 78.7 |

Gloss after Crockmeter Marring

| | | |
|---|---|---|
| Average Gloss at 20 deg | 70.6 | 70.0 |

Gloss Retention after Crockmeter Marring, %

| | | |
|---|---|---|
| Gloss at 20 deg | 91.4% | 88.9% |
| Mar Resistant | Marred area | Marred area |
| Test Comment | almost not visible | almost not visible |

Amine Mixture #1: 33.3% bis(2,2,6,6-tetramethyl-4-piperidinyl)sebacate, 33.3% Poly(4-hydroxy-2,2,6,6-tetramethyl-1-piperidine ethanol-alt-1,4-butanedioic acid), 33.4% 2-(2′-Hydroxy -3′,5′-ditert-butylphenyl)-benzotriazole.

Amine Mixture #2: 33.3% bis(2,2,6,6-tetramethyl-4-piperidinyl) sebacate, 33.3% Poly(4-hydroxy-2,2,6,6-tetramethyl-1-piperidine ethanol-alt-1,4-butanedioic acid), 33.4% 2-hydroxyl-4-n-octoxybenzophenone.

Invention examples 5 and 6 show that, if combined with polydimethylsiloxane, mixtures of organic amines will yield the high specular gloss retention and mar resistance that is characteristic of the alloys of this invention.

TABLE IV
Operating Examples with Acid or Triazine as Mar Resistant

| | Example | | |
|---|---|---|---|
| | Example | Example | Example |
| | #7 | #8 | #9 |
| Mar Resistant Additives | Succinic Acid | Fumaric Acid | Melamine |
| Lubricant Additive | PDMS | PDMS | PDMS |
| Pueblo Gold Color Conc. | 5.50% | 5.50% | 5.50% |
| Polypropylene | 74.30% | 74.30% | 74.30% |
| SEBS | 18.00% | 18.00% | 18.00% |
| Irganox B225 | 0.10% | 0.10% | 0.10% |
| Mar Resistant Additives | 0.60% | 0.60% | 0.60% |
| Lubricant Additive | 1.50% | 1.50% | 1.50% |
| Total (%) | 100.0% | 100.00% | 100.0% |

Properties
Initial Gloss-High Gloss 4″ × 8″ × 3 mm mold

| | | | |
|---|---|---|---|
| Average Gloss at 20 deg | 73.0 | 75.4 | 71.0 |

Gloss after Crockmeter Marring

| | | | |
|---|---|---|---|
| Average Gloss at 20 deg | 69.5 | 60.1 | 43.4 |

Gloss Retention after Crockmeter Marring, %

| | | | |
|---|---|---|---|
| Gloss at 20 deg | 95.2% | 79.7% | 61.1% |
| Mar Resistant | Marred area | Marred area | Marred area |
| Test Comment | almost not | almost not | slightly |
| | visible | visible | visible |

Invention examples 7-9 show that other amines and organic acids, when combined with polydimethylsiloxane, demonstrate the surprising gloss retention and mar resistance results of this invention.

TABLE V
Operating Examples with Inorganic Salts as Mar Resistant Additives

| | Example | |
|---|---|---|
| | Example | Example |
| | #10 | #11 |
| Mar Resistant Additives | NaCl | CaCO3 |
| Lubricant Additive | PDMS | PDMS |
| Pueblo Gold Color Conc. | 5.50% | 5.50% |
| Polypropylene | 74.30% | 74.30% |
| SEBS | 18.00% | 18.00% |
| Irganox B225 | 0.10% | 0.10% |
| Mar Resistant Additives | 0.60% | 1.00% |
| Lubricant Additive | 1.50% | 1.50% |
| Total (%) | 100.0% | 100.4% |

Properties
Initial Gloss-High Gloss 4″ × 8″ × 3 mm mold

| | | |
|---|---|---|
| Average Gloss at 20 deg | 63.6 | 68.5 |

Gloss after Crockmeter Marring

| | | |
|---|---|---|
| Average Gloss at 20 deg | 53.4 | 34.1 |

Gloss Retention after Crockmeter Marring, %

| | | |
|---|---|---|
| Gloss at 20 deg | 84.0% | 49.9% |
| Mar Resistant | Low initial gloss, | Marred area visible |
| Test Comment | Marred area only | |
| | slightly visible | |

Invention Examples 10 and 11 show that alkali metal and alkaline earth metal compounds, when combined with polydimethylsiloxane, exhibit the surprising gloss retention and mar resistance results of this invention.

Although not known to a certainty, and, therefore, not desiring to be limited thereto, it is presently though that, based on the foregoing operating examples, the grouping of organic amines, organic acids, triazynyl compounds, alkali metal halides, alkaline earth metal compounds, polyolefin grafted or copolymerized with polar monomers, and aluminum hydroxide is suggested because these chemicals and polymers are chemically incompatible with polydimethylsiloxane and thereby tend to drive polydimethylsiloxane to the surface of the alloy to form a protective layer that has superior resistance to mar abrasion.

I claim:

1. A method for forming a thermoplastic alloy that upon forming into an article exhibits 1) an initial specular gloss of at least about 70 measured at a 20° glossmeter geometry, 2) a specular gloss retention of at least about 65% of said initial specular gloss as measured by a crockmeter mar test, and substantial resistance to visible marring, said method comprising preparing a blend consisting essentially of the components
A) from about 60 wt. % to about 95 wt. % of at least one polymer selected from the group consisting of amorphous polymer and semi-crystalline polymer,
B) from about 0.5 wt. % to about 3 wt. % polydialkylsiloxane, and
C) from about 0.2 wt. % to about 0.95 wt. % of at least one material selected from the group consisting of the subgroups 1) at least one organic amine having a boiling point of at least about 150° C. and a molecular weight of from about 110 to about 5,000, 2) at least one organic acid having a boiling point of at least about 150° C. and a molecular weight of from about 120 to about 3,000, 3) at least one triazynyl compound having a boiling point of at least about 150° C. and a molecular weight of from about 200 to about 5,000, 4) at least one alkali metal halide, 5) at least one alkaline earth metal compound, 6) at least one polyolefin backbone which is at least one of grafted or copolymerized with at least one of maleic anhydride, acrylic acid, and acrylic amide, and 7) aluminum hydroxide, all wt. % being based on the total weight of said alloy.

2. The method of claim 1 wherein said component A) is selected from the group consisting of a homopolymer of propylene, a copolymer of at least 50 wt. % propylene and at least one other C2 to C20 alpha-olefin, acrylonitrile-butadiene-styrene copolymer, styrene-acrylonitrile copolymer, styrene-maleic anhydride copolymer, polymethylmethacrylate, poly(aromatic carbonate)s, and mixtures of two or more thereof.

3. The method of claim 1 wherein at least one compatibilizer is added in an amount up to about 30 wt. %, said compatibilizer being selected from the group consisting of styrene-butadiene-styrene, styrene-ethylene/butylene-styrene, styrene-ethylene/propylene-styrene, a copolymer of ethylene and at least one other C3 to C20 alpha-olefin, ethylene propylene ethylidene norbornene, and mixtures of two or more thereof.

4. The method of claim 1 wherein said component B) is a polydimethylsiloxane having the repeating formula —[—Si(CH₃)₂—O—]ₙ—, and a molecular weight of from about 1,000 to about 1,000,000.

5. The method of claim 1 wherein said subgroups 1) through 7) of material C) are selected from the group consisting of 1) piperidinyl amine, melamine; 2) organic acids having from 4 to 20 carbon atoms per molecule; 3) triazine; 4) alkali metal halides; 5) alkaline earth metal bases, alkaline earth metal salts; 6) grafted polyolefin backbones of an olefin having from 2 to 12 carbon atoms per molecule; and 7) aluminum hydroxide.

6. The method of claim 1 wherein said subgroups 1) through 7) of material C) are selected from the group consisting of a) bis(2,2,6,6-tetramethyl-4-piperidinyl)sebacate; b) poly(4-hydroxy-2,2,6,6-tetramethyl-1-piperidine ethanol-alt-1,4-butanedioic acid); c) decanedioic acid bis(2,2,6,6-tetramethyl-1-(octyloxy)-4-piperidinyl)ester; d) poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; e) a mixture of a), b), and 2-(2′-hydroxy-3′,5′-ditert-butylphenyl)-benzotriazole; f) a mixture of a), b), and 2-hydroxyl-4-n-octoxybenzophenone; g) melamine; h) fumaric acid; i) succinic acid; j) triazine; k) sodium chloride; l) sodium bromide; m) sodium iodide; n) potassium chloride; o) potassium bromide; p) potassium iodide; q) calcium carbonate; r) magnesium carbonate; s) calcium hydroxide; t) magnesium hydroxide; u) aluminum hydroxide; and v) at least one polyolefin backbone of an olefin having from 2 to 12 carbon atoms per molecule which is at least one of grafted or copolymerized with from about 0.5 wt. % to about 10 wt. % based on the total weight of said polyolefin with at least one of maleic anhydride, acrylic acid and acrylic amide.

7. The method of claim 1 wherein said material C) is at least one material selected from the group consisting of bis(2,2,6,6-tetramethyl-4-piperidinyl)sebacate; poly(4-hydroxy-2,2,6,6-tetramethyl-1-piperidine ethanol-alt-1,4-butanedioic acid); decanedioic acid bis(2,2,6,6-tetramethyl-1-(octyloxy)-4-piperidinyl) ester; poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-(2′-hydroxy-3′,5′-ditert-butyl phenyl)-benzotriazole; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-hydroxyl-4-n-octoxybenzophenone; melamine; fumaric acid; succinic acid; triazine; sodium chloride; and calcium carbonate.

8. The method of claim 1 wherein said alloy is formed by mixing components A) through C) at a temperature of from about 165° C. to about 250° C.

9. The method of claim 1 wherein at least one conventional additive is mixed into said alloy, and the amount of component C) employed in said alloy is in addition to the amount of said conventional additive mixed into said alloy.

10. A composition consisting essentially of the components
A) from about 60 wt. % to about 95 wt. % of at least one polymer selected from the group consisting of amorphous polymer and semi-crystalline polymer,
B) from about 0.5 wt. % to about 3 wt. % polydialkylsiloxane, and
C) from about 0.2 wt. % to about 0.95 wt. % of at least one material selected from the group consisting of the subgroups 1) at least one organic amine having a boiling point of at least about 150° C. and a molecular weight of from about 110 to about 5,000, 2) at least one organic acid having a boiling point of at least about 150° C. and a molecular weight of from about 120 to about 3,000, 3) at least one triazynyl compound having a boiling point of at least about 150° C. and a molecular weight of from about 200 to about 5,000, 4) at least one alkali metal halide, 5) at least one alkaline earth metal compound, 6) at least one polyolefin backbone which is at least one of grafted or copolymerized with at least one of maleic anhydride, acrylic acid, and acrylic amide, and 7) aluminum hydroxide, all wt. % being based on the total weight of said alloy.

11. The composition of claim 10 wherein said component A) is selected from the group consisting of a homopolymer of propylene, copolymer of at least 50 wt. % propylene and at least one other C2 to C20 alpha-olefin, acrylonitrile-butadiene-styrene copolymer, styrene-acrylonitrile copolymer, styrene-maleic anhydride copolymer, polymethylmethacrylate, poly(aromatic carbonate)s, and mixtures of two or more thereof.

12. The composition of claim 10 wherein at least one compatibilizer is added in an amount up to about 30 wt. %, said compatibilizer being selected from the group consisting of styrene-butadiene-styrene, styrene-ethylene/butylene-styrene, styrene-ethylene/propylene-styrene, a copolymer of ethylene and at least one other C3 to C20 alpha-olefin, ethylene propylene ethylidene norbornene, and mixtures of two or more thereof.

13. The composition of claim 10 wherein said component B) is a polydimethylsiloxane having the formula —[—Si(CH₃)₂—O—]ₙ—, and a molecular weight of from about 1,000 to about 1,000,000.

14. The composition of claim 10 wherein said subgroups 1) through 7) of material C) are selected from the group consisting of 1) piperidinyl amine, melamine; 2) organic acids having from 4 to 20 carbon atoms per molecule; 3) triazine; 4) alkali metal halides; 5) alkaline earth metal bases, alkaline earth metal salts; 6) grafted polyolefin backbones of an olefin having from 2 to 12 carbon atoms per molecule; and 7) aluminum hydroxide.

15. The composition of claim 10 wherein said subgroups 1) through 7) of material C) are selected from the group consisting of a) bis(2,2,6,6-tetramethyl-4-piperidinyl)sebacate; b) poly(4-hydroxy-2,2,6,6-tetramethyl-1-piperidine ethanol-alt-1,4-butanedioic acid); c) decanedioic acid bis(2,2,6,6-tetramethyl-1-(octyloxy)-4-piperidinyl)ester; d) poly[[6-[(1,1,3,3-tetramethylbutyl )amino]-s-triazine-2,4-diyl]-[(2,2,6,6-tetramethyl-4-piperidyl)imino]-hexamethylene-[(2,2,6,6-tetramethyl-4-piperidyl)imino]]; e) a mixture of a), b), and 2-(2′-hydroxy-3′,5′-ditert-butylphenyl)-benzotriazole; f) a mixture of a), b), and 2-hydroxyl-4-n-octoxybenzophenone; g) melamine; h) fumaric acid; i) succinic acid; j) triazine; k) sodium chloride; l) sodium bromide; m) sodium iodide; n) potassium chloride; o) potassium bromide; p) potassium iodide; q) calcium carbonate; r) magnesium carbonate; s) calcium hydroxide; t) magnesium hydroxide; u) aluminum hydroxide; and v) at least one polyolefin backbone of an olefin having from 2 to 12 carbon atoms per molecule grafted or copolymerized with from about 0.5 wt. % to about 10 wt. % based on the total weight of said polyolefin with at least one of maleic anhydride, acrylic acid and acrylic amide.

16. The composition of claim 10 wherein said material C) is at least one material selected from the group consisting of bis(2,2,6,6-tetramethyl-4-piperidinyl)sebacate; poly(4-hydroxy-2,2,6,6-tetramethyl-1-piperidine ethanol-alt-1,4-butanedioic acid); decanedioic acid bis(2,2,6,6-tetramethyl-1-(octyloxy)-4-piperidinyl)ester; poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-(2′-hydroxy-3′,5′-ditert-butylphenyl)-benzotriazole; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-hydroxyl-4-n-octoxybenzophenone; melamine; fumaric acid; succinic acid; triazine; sodium chloride; and calcium carbonate.

17. The composition of claim 10 wherein at least one conventional additive is present in said alloy, and the amount of component C) present in said alloy is in addition to the amount of said conventional additive present.

18. A molded article of the composition of claim 10.

19. An extruded article of the composition of claim 10.

20. A thermoplastic additive consisting essentially of from about 0.3 wt. % to about 3 wt. % polydialkylsiloxane, the remainder being at least one material selected from the group consisting of 1) at least one organic amine having a boiling point of at least about 150° C. and a molecular weight of from about 110 to about 5,000; 2) at least one organic acid having a boiling point of at least about 150° C. and a molecular weight of from about 120 to about 3,000; 3) at least one triazynyl compound having a boiling point of at least about 150 C. and a molecular weight of from about 200 to about 5,000; 4) at least one alkali metal halide; 5) at least one alkaline earth metal compound; 6) at least one polyolefin backbone which is at least one of grafted or copolymerized with at least one of maleic anhydride, acrylic acid, and acrylic amide; and 7) aluminum hydroxide, all wt. % being based on the total weight of said additive.

21. The additive of claim 20 wherein said polydialkylsiloxane is a polydimethylsiloxane having the formula —[—Si(CH₃)₂—O—]ₙ—, and a molecular weight of from about 1,000 to about 1,000,000.

22. The method of claim 20 wherein said at least one material is selected from the group consisting of piperidinyl amine, melamine; organic acids having from 4 to 20 carbon atoms per molecule; triazine; alkali metal halides; alkaline earth metal bases, alkaline earth metal salts; grafted polyolefin backbones of an olefin having from 2 to 12 carbon atoms per molecule; and aluminum hydroxide.

23. The additive of claim 20 wherein said at least one material is selected from the group consisting of a) bis(2,2,6,6-tetramethyl-4-piperidinyl)sebacate; b) poly(4-hydroxy-2,2,6,6-tetramethyl-1-piperidine ethanol-alt-1,4-butanedioic acid); c)decanedioic acid bis(2,2,6,6-tetramethyl-1-(octyloxy)-4-piperidinyl) ester; d) poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; e) a mixture of a), b), and 2-(2′-hydroxy-3′,5′-ditert-butylphenyl)-benzotriazole; f) a mixture of a), b), and 2-hydroxyl-4-n-octoxybenzophenone; g) melamine; h) fumaric acid; i) succinic acid; j) triazine; k) sodium chloride; l) sodium bromide; m) sodium iodide; n) potassium chloride; o) potassium bromide; p) potassium iodide; q) calcium carbonate; r) magnesium carbonate; s) calcium hydroxide; t) magnesium hydroxide; u) aluminum hydroxide; and v) at least one polyolefin backbone of an olefin having from 2 to 12 carbon atoms per molecule which is at least one of grafted or copolymerized with from about 0.5 wt. % to about 10 wt. % based on the total weight of said polyolefin with at least one of maleic anhydride, acrylic acid and acrylic amide.

24. The additive of claim 20 wherein said at least one material is selected from the group consisting of bis(2,2,6,6-tetramethyl-4-piperidinyl)sebacate; poly(4-hydroxy-2,2,6,6-tetramethyl-1-piperidine ethanol-alt-1,4-butanedioic acid); decanedioic acid bis(2,2,6,6-tetramethyl-1-(octyloxy)-4-piperidinyl)ester; poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino]]; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-(2′-hydroxy-3′,5′-ditert-butylphenyl)-benzotriazole; a mixture of bis(2,2,6,6-tetramethyl-4-piperidinyl)sebacate, poly(4-hydroxy-2,2,6,6-tetramethyl-1-piperidine ethanol-alt-1,4-butanedioic acid), and 2-hydroxyl-4-n-octoxybenzophenone; melamine; fumaric acid; succinic acid; triazine; sodium chloride; and calcium carbonate.

25. A method for making the additive of claim 20 wherein the components of said additive are mixed at a temperature of from about 165° C. to about 250° C.
